(19) United States
(12) Patent Application Publication
(10) Pub. No.: US 2009/0030682 A1
(43) Pub. Date: Jan. 29, 2009

(54) System and method for publishing media files

(75) Inventors: Richard VanSickle, Carlsbad, CA (US); Tim Paulino, Yorba Linda, CA (US); Eric Thomas, Encinitas, CA (US)

Correspondence Address: MILBANK, TWEED, HADLEY & MCCLOY, 1 CHASE MANHATTAN PLAZA, NEW YORK, NY, 10005-1413, US

(73) Assignee: Call Catchers, Inc.

(21) Appl. No.: 11/880,532

(22) Filed: Jul. 23, 2007

(51) Int. Cl. G10L 15/00

(52) U.S. Cl. 704/235

(57) ABSTRACT

A method for publishing a digital media file. The method includes the steps of receiving the digital media file containing speech, converting the speech to text, identifying a keyword in the text, retrieving, for the keyword, a corresponding URL from a database, inserting into the text a hyperlink linking the keyword with the corresponding URL, and making the media file and the text available to a subscriber.

### BACKGROUND

The present disclosure relates to a system and method for publishing recordings for inclusion in web feeds including, but not limited to, podcasts. More particularly, the present disclosure relates to a system and method for generating a transcript for a recording and hyperlinking URLs to keywords within the transcript.

A web feed is a data format designed to allow individuals to easily subscribe to and receive digital media content. Digital media content may be text, audio, and video files that may be transferred over a network, then stored and reproduced electronically, for example, using a computer or digital media player. A podcast is one type of web feed. A podcast typically includes an audio file, usually encoded in an MP3 audio format, and may include information related to the audio file, such as a description of the audio file.

Once a podcast has been created, a content provider may post the podcast on a publicly available web server. The content provider may post podcasts periodically, where each podcast may be considered an episode in a series. Once posted, each podcast may be assigned a unique URL, which may be used to access the podcast. The content provider may then publish the podcast by including the URL assigned to the podcast in another file known as a feed. The feed may be provided in one or more of several standardized formats, including RSS and Atom. These formats may also allow the content provider to offer additional information about the podcast episode, such as the publish date, title, and description of the podcast episode. An aggregator program may be configured to periodically check one or more feeds for new podcast episodes and automatically transfer those new episodes to the subscriber.

Historically, each feed included podcast episodes created by a single author. Public or social podcasting, in which a feed may include podcast episodes created by multiple authors, has become more common. One reason for the increase in popularity of social podcasting may be due to a process known as phonecasting, which allows individuals to use the telephone service to record, publish, and retrieve podcasts. By calling a predetermined telephone number and accessing an account, usually by entering a PIN, a caller may record a message that is saved and converted to an MP3 audio file that may be included as an episode in a feed and that may be distributed to subscribers.

It may be desirable to have a system where the description of a podcast episode contains a transcript of the words recorded in the audio file. Using a process known as search engine optimization (SEO), websites use choice and placement of words to increase relevance and ranking by search engines compared to other websites. Including a transcript and making the transcript available to search engines may increase the relevance of a podcast and the related website. Increased relevance results in higher ranking in search engines thereby increasing awareness of and subscription to the podcast feed.

It may also be desirable to have a system where words in the transcript are hyperlinked to relevant related web sites.

It may further be desirable to have a system where podcast is automatically posted to one or more podcast directories.

### SUMMARY

The present disclosure relates to a method for publishing a digital media file. In one aspect, the method includes the steps of receiving the digital media file containing speech, converting the speech to text, identifying a keyword in the text, retrieving, for the keyword, a corresponding URL from a database, inserting into the text a hyperlink linking the keyword with the corresponding URL, and making the media file and the text available to a subscriber.

### BRIEF DESCRIPTION OF THE DRAWINGS

The drawings of this disclosure relate to an overview of the system and functions of the system.

FIG. 1 shows an overview diagram of the system according to one aspect of the system and method of the present disclosure.

FIG. 2 shows a flowchart according to one aspect of the system and method of the present disclosure.

FIG. 3 shows an overview diagram of the system according to one aspect of the system and method of the present disclosure.

FIG. 4 shows a diagram of folders of the system according to one aspect of the system and method of the present disclosure.

### DETAILED DESCRIPTION

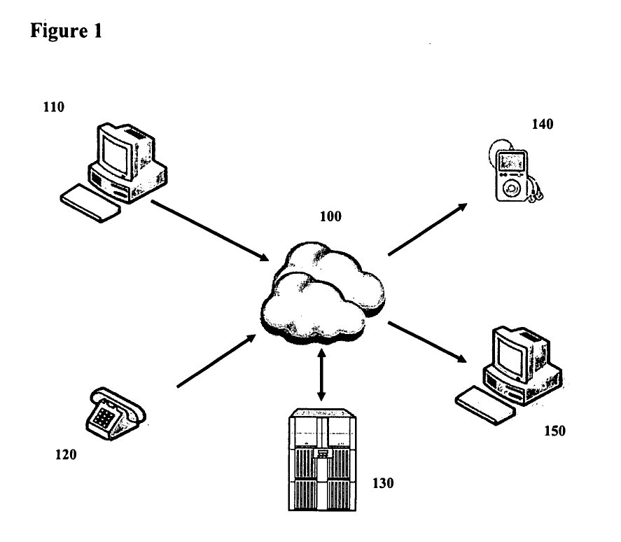

As shown in FIG. 1, the system and method of the present disclosure may interface with a network 100, which may be the internet or some other public or private interconnection of computing resources. The system may include computer 110 to administer and publish feeds, edit podcast episodes, and update dictionaries. Episodes may be created by phonecasting using an input device, such as telephone 120 through POTS (plan old telephone service) or VOIP (voice over internet protocol), cellular phone, or computer with microphone. Episodes may be created from telephone messages, telephone conversations, and conference calls. Episodes containing still images or video may be created using cameras, camcorders, and webcams. Episodes may be stored at server 130. Server 130 may also host feeds and handle back-end processing, such as transcription of audio recordings to text for inclusion as the episode description. Server 130 may be one or more computer servers used to distribute load or distribute different types of processing. Server 130 may allow the feeds to be publicly available through the internet for feed subscribers. Subscribers may obtain and reproduce feeds through electronic devices, such as portable media device 140 or computer 150.

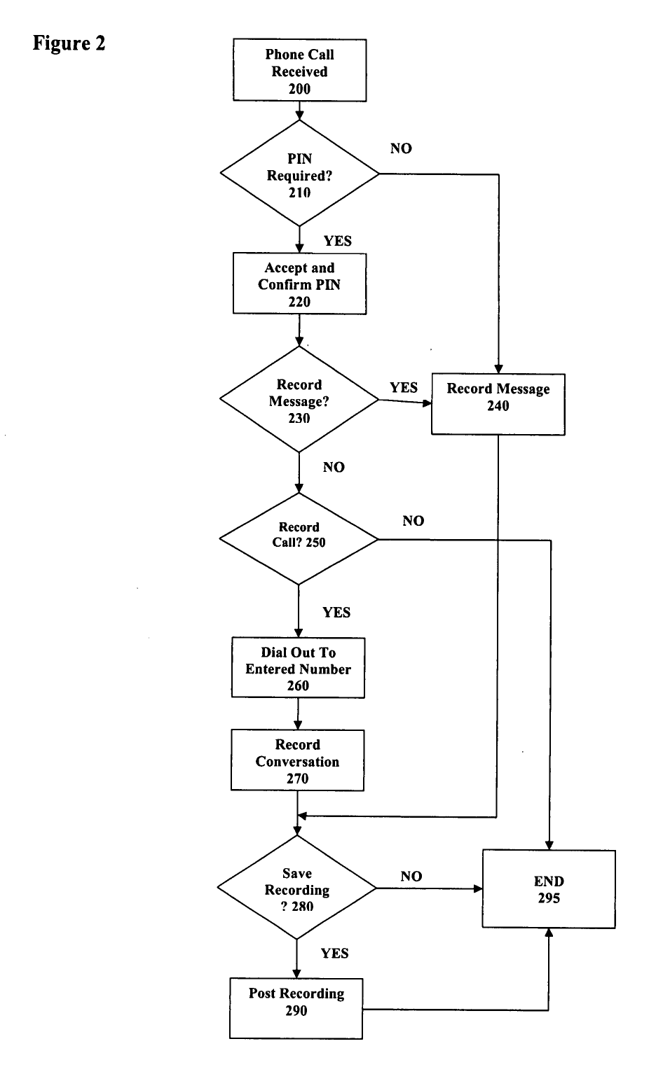

As shown in FIG. 2, a recording may be created by calling a predetermined telephone number corresponding to a phonecasting system. Step 200 shows the incoming call from a caller. In one aspect, the caller may use telephone 120 (FIG. 1) to connect with voice mail software running on servers 130 (FIG. 1). In Step 210, the system then determines whether a PIN is required to access the system. If a PIN is not required (NO, Step 210), then the caller may have immediate access to record a message at Step 240. Upon completion of the message, the caller may be prompted whether to save the recording at Step 280. If it is successfully confirmed to be saved (YES, Step 280), then the message is posted to the web portal at Step 290, and the call is terminated at Step 295. Otherwise (NO, Step 280), the call is terminated at Step 295 with the recording not saved.

If a PIN is required (YES, Step 210), no further access is given until a valid PIN is entered at Step 220. Next, at Step 230, the user may receive an option to record a message or to record a phone call with one or more parties. If the user chooses to record a message (YES, Step 230), then the message is recorded at Step 240, a confirmation is made at Step 280 and the message is either posted (YES, Step 280) at Step 290 and the call terminated at Step 295 or (NO, Step 280) the call is terminated without the recording saved at Step 295.

If the option to record a message is not selected (NO, Step 230) and the option to record a phone call is selected (YES, Step 250), the caller is provided with an outbound line to place a call to conference another party to the recording at Step 260. This can also optionally be utilized to record a teleconference call with multiple parties. Prior to recording the call, one or more of the parties may be notified that the call is being recorded and that the call, including the parties' voices and the transcript, may be made publicly available. Once the call is completed, a confirmation to save is given at Step 280, the recording is posted at Step 290 and the call is terminated at Step 295 or (NO, Step 250) the call is terminated without saving at Step 295.

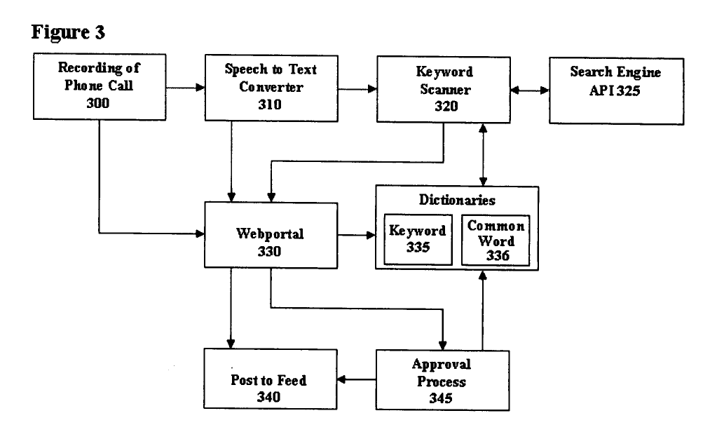

As shown in FIG. 3, once Recording 300 has been posted (Step 290 in FIG. 2), Recording 300 may be made available to Speech to Text Converter 310 and Web Portal 330. Recording 300 may be available in Web Portal 330 where Recording 300 and associated data may be manipulated and posted to an RSS or Atom feed at Post to Feed 340. As will be described in more detail below, feeds, in context of Web Portal 330, may be organized using folders. Episodes may be the audio or video files organized within the folders along with one or more associated files that may contain additional relevant information, such as the name, description, data type, file size/length, and published date of the audio or video file. In one aspect of the present disclosure, this additional information may be stored as XML tagged data. In another aspect, a folder may not be considered an active feed until the folder is published to an RSS or Atom feed. Folders may be arranged in a manner similar to email or operating systems that store folders and files. In one aspect, all new recordings may be stored in a default folder, which may be a published folder, i.e., a feed, or a non-published folder. In one configuration, a user may wish to have Recording 300 automatically stored in a published folder and offered as a feed, as in the case of a social podcasting application. Publishing folders or posting a feed may be controlled using a user-selectable field in the Web Portal 330, for example, where the options may be either published or non-published.

Transcribe Recording

Recording 300 containing speech may be transcribed using Speech-to-Text Converter 310 and the resulting transcript may be included in a file and marked with an episode “description” XML tag. Recording 300 may be automatically routed to Speech-to-Text Converter 310 as controlled by a user-selectable field set through Web Portal 330. This field setting may apply to individual files or may apply to all files within a folder. In one aspect, this field setting may be required for the default folder. A user may edit the episode description, including the transcript, through Web Portal 330 and may correct any transcription anomalies, provide additional text, or otherwise change the description. Once a transcript has been generated, as discussed below, the system may scan the transcript for keywords or phrases, then hyperlink URL's to those keywords or phrases in the transcript.

Scan Transcript for Keywords

Keyword Scanner 320 may identify keywords in the transcript using an algorithm designed to exclude certain common words or phrases and focus on other frequently-repeated words or phrases. In one aspect, the algorithm may first count the frequency of each word or phrase within the transcript. Next, the most frequently occurring words or phrases may be compared to Common Word Dictionary 336 that may contain words or phrases that may not receive hyperlinks, such as conjunctions and prepositions. The most frequently occurring words or phrases in the transcript that are present in Common Word Dictionary 336 may be excluded from further evaluation. The system identifies as keywords the remaining frequently occurring words or phrases in the transcript, and may assign URLs to the keywords as discussed below.

Access Keyword Dictionary

Keyword Dictionary 335 may be used to allow the user to make specific inclusions or exclusions for keywords and assign URLs to keywords. Entries in Keyword Dictionary 335 may contain fields including (1) a keyword field, which may include one or more words; (2) a field indicating the status of the entry; and (3) a URL field. Users may enter and update Keyword Dictionary 335 through an interface in Web Portal 330.

When the status field for a keyword is set to “Include”, then the URL listed in the URL field for that entry may be included automatically or suggested as the URL to associate with the keyword during Approval Process 345. When the status field for a keyword is set to “Exclude”, then the keyword will be not be hyperlinked to the one or more URL(s) listed in the corresponding URL field, but the keyword may be hyperlinked to other URL(s), such as those returned from search engines. When the status field for a keyword is set to “Exclude All”, then the keyword will not be hyperlinked to any URL. An example of Keyword Dictionary 335 is shown in Table 1 below.

TABLE 1

| Keyword | Status | URL |
|---|---|---|
| Tire | Include | www.tires.com |
| Car Rental | Exclude | www.carrental.com |
| Pipe | Exclude All | — |

As shown in Table 1 above, the first entry in Keyword Dictionary 335 contains keyword “Tire”, and the status field is set to “Include”. As a result, each reference to the keyword “Tire” in the transcript may be hyperlinked to the URL found in the URL field for that entry, in this case, www.tires.com. The second entry in Keyword Dictionary 335 contains keyword “Car Rental”, and the status field is set to “Exclude”. Therefore, references to the keyword “Car Rental” in the transcript may not be hyperlinked to the URL www.carrental.com, but may be hyperlinked to other URL's. The third entry in Keyword Dictionary 335 contains keyword “Pipe”, and the status field is set to “Exclude All”. As a result, references to the keyword “Pipe” in the transcript may not be hyperlinked to any URL.

As described above, the system may access Keyword Dictionary 335 after accessing Common Word Dictionary 336. In another aspect, during scanning by Keyword Scanner 320, the system may access Keyword Dictionary 335 before accessing Common Word Dictionary 336 to provide hyperlinks for certain words that would otherwise be filtered by Common Word Dictionary 336. In another aspect, the contents of Common Word Dictionary 336 may be the same for all users, while the contents of Keyword Dictionary 335 may be customized for or by each user.

Submit Keywords to Search Engines

The system may retrieve URLs from one or more search engines using Search Engine API's (application program interfaces) 325, such as Google AJAX Search API, Yahoo! Search, and MSDN Live Search API. Search Engine API's 325 may operate via HTTP requests and may generally be formed by submitting a starting service point URL for one or more selected search engines along with added query arguments for the specific search results desired. The user may select the number of keywords submitted as query arguments, expressed as raw number or as a percentage of eligible words, through a user-selectable field in Web Portal 330.

The one or more selected search engines may return results that may be parsed by Keyword Scanner 320 to extract the URL that may be inserted and hyperlinked to keywords in the transcript. This may include selecting the top ranked URL or the top several ranked URL's from the search engine results.

Hyperlink URLs to Keywords in Transcript

Hyperlinks for keywords may be inserted in the transcript automatically or selected manually by the user through Approval Process 345. During the automatic insertion process, user approval may not be required, and the top-ranked URL received from Search Engine API 325 for a keyword may be provided as the hyperlink for one or more instances of that keyword in the transcript. During the manual insertion process, the user may approve or deny suggested hyperlinks on a keyword-by-keyword basis, and one or more alternate URL's may be presented for each keyword. In one aspect, the user's responses may cause URL's received via Search Engine API 325 to be automatically added to Keyword Dictionary 335 for inclusion to or exclusion from future transcripts.

Once the hyperlinks have been inserted into the transcript, the system may save the revised transcript containing the hyperlinks. The user may edit the transcript through Web Portal 330 and may select which version of the transcript will accompany the episode.

The user may select between creating hyperlinks for all occurrences of a keyword in a transcript or for only the first occurrence of the keyword. This parameter may be set through a user selectable field in Web Portal 330. Once hyperlinks are added to the transcript, Web Portal 330 may be used to edit the transcript and descriptions to add, remove, or edit text and hyperlinks.

In another aspect, Keyword Scanner 320 may access Keyword Dictionary 335 after, or instead of, submitting the keyword to Search Engine API 325.

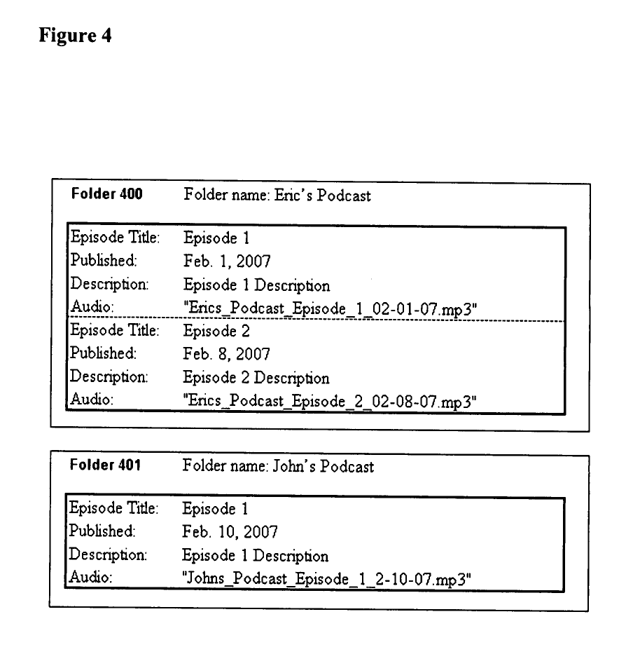

FIG. 4 shows a more detailed view of the folder structure hosted on Server 130 and accessed through Web Portal 330. Upon accessing Web Portal 330, the user may have the ability to view and manage folders on the system. Multiple folders or feeds within a system may be created and hosted simultaneously. In FIG. 4, folder 400 contains two episodes, while folder 401 contains one episode. As shown in FIG. 4, an episode may include the audio or video file within the folders, as well as one or more associated files containing the title, description, and publication date of the audio or video file. The episode may include an author field, which may include information identifying the author of the episode. In one aspect, the system may use the telephone number of the caller to directly or indirectly identify the author.

New folders may be created to provide additional feeds. Web Portal 330 may allow the user to modify, edit, or delete episodes within a folder or delete the folder. Episodes may be moved or copied from one folder to another.

Parameters associated with each feed that may be manipulated by the user through Web Portal 330 are included in Table 2 below.

TABLE 2
Folder Parameters

| | |
|---|---|
| Default Folder | Y/N |
| Published | Y/N |
| Auto Transcribe | Y/N |
| Use Keyword Dictionary | Y/N |
| Scan for Keywords | Y/N |
| Approval Required | Y/N |
| Populate Dictionary on Approval | Y/N |
| Hyperlink First Reference Only | Y/N |
| Number/Percentage of Keywords | [number] |

As discussed above, a folder designated as the “Default Folder” may receive all newly created audio files (Step 290 in FIG. 2). One folder may be set as the default folder at any given time. “Published” indicates whether the folder may be publicly available, i.e., whether the URL for that folder will be made available to an aggregator. “Transcribe” indicates whether new audio files added to that folder will be automatically converted to text at Speech-to-Text Converter 310 and the text added to the episode description. “Use Keyword Dictionary” indicates whether Keyword Dictionary 335 will be utilized to create hyperlinks in the text. This parameter may be set to “Yes” even though the Transcribe parameter is set to “No”, as the episode description may be manually created and edited through Web Portal 330. “Scan for Keywords” indicates whether the algorithm to search for relevant words in the episode description by Keyword Scanner 320 will be utilized. “Approval Required” indicates whether Approval Process 345 is required for hyperlinks obtained through Search Engine API 325. “Populate Dictionary on Approval” indicates whether approved or denied keywords/hyperlinks may automatically be added to Keyword Dictionary 320. “Hyperlink First Reference Only” indicates whether hyperlinks may be created for only the first occurrence of a keyword in the episode description or for all occurrences of the keyword in the episode description. “Number/Percentage of Keywords” may indicates the number of keywords that may be searched utilizing the Search Engine API 325 expressed as either a raw number or as a percentage of non-common unique words located within the episode description.

Although illustrative embodiments have been described herein in detail, it should be noted and will be appreciated by those skilled in the art that numerous variations may be made within the scope of this invention without departing from the principle of this invention and without sacrificing its chief advantages.

Unless otherwise specifically stated, the terms and expressions have been used herein as terms of description and not terms of limitation. There is no intention to use the terms or expressions to exclude any equivalents of features shown and described or portions thereof and this invention should be defined in accordance with the claims that follow.

1. A method for publishing a digital media file, comprising the steps of:
a. receiving the digital media file containing speech;
b. converting the speech to text;
c. identifying a keyword in the text;
d. retrieving, for the keyword, a corresponding URL from a database;
e. inserting into the text a hyperlink linking the keyword with the corresponding URL; and
f. making the media file and the text available to a subscriber.

2. The method of claim 1, further comprising:
g. storing the media file and the text in a folder; and
h. designating the folder so that media files and texts stored in the folder are automatically made available to the subscriber.

3. The method of claim 1, further comprising, prior to step (a):
receiving a call from a party, during which the party records the digital media file.

4. The method of claim 1, further comprising, prior to step (a):
receiving a call from a party; and
initiating a call to a second party; during which the party and the second party record the digital media file.

5. The method of claim 1, wherein step (c) is performed by a user.

6. The method of claim 1, wherein step (c) further comprises,
counting the frequency of words in the text; and
identifying as keywords those words that are a highest predetermined percentage of the most frequently appearing words in the text.

7. The method of claim 1, wherein in step (c), words that appear in a pre-populated database are not keywords.

8. The method of claim 1, wherein the text is stored in an episode description field of a file.

9. The method of claim 1, wherein step (d) further comprises sending a search request to a search engine via a network and receiving one or more URLs in response.

10. The method of claim 1, wherein the URL linked to each of the one or more keywords is the highest ranked URL received during step (d).

11. The method of claim 1, wherein step (d) further comprises accessing a database containing one or more keywords and corresponding URLs.

12. The method of claim 1, wherein step (d) further comprises accessing a database containing one or more keywords and for each of the one or more keywords at least one of a corresponding URL and a corresponding status field.

13. The method of claim 12, wherein the status field determines whether, during step (e), to perform one of the following: include a hyperlink to the corresponding URL; exclude a hyperlink to the corresponding URL; and exclude a hyperlink to all URLs for the corresponding keyword.

14. The method of claim 1, wherein during step (e), a user selects the URL linked to each of the one or more keywords from one of a predetermined number of highest ranked URLs received during step (d).

15. The method of claim 1, wherein step (e) further comprises inserting into the text a hyperlink for the first occurrence of each of the one or more keywords.

16. The method of claim 1, wherein step (e) further comprises inserting into the text a hyperlink for the all occurrences of each of the one or more keywords.

17. The method of claim 1, wherein the digital media file includes a telephone message by one party.

18. The method of claim 1, wherein the digital media file includes a telephone conversation between two or more parties.

19. A computer storage medium embodying computer executable software code for publishing a digital media file, the code comprising the steps of:
a. receiving the digital media file containing speech;
b. converting the speech to text;
c. identifying a keyword in the text;
d. retrieving, for the keyword, a corresponding URL from a database;
e. inserting into the text a hyperlink linking the keyword with the corresponding URL; and
f. making the media file and the text available to a subscriber.

20. A programmed computer system including a processor for executing software code for publishing a digital media file, the code comprising the steps of:
a. receiving the digital media file containing speech;
b. converting the speech to text;
c. identifying a keyword in the text;
d. retrieving, for the keyword, a corresponding URL from a database;
e. inserting into the text a hyperlink linking the keyword with the corresponding URL; and
f. making the media file and the text available to a subscriber.
